(19) United States
(12) Patent Application Publication
(10) Pub. No.: US 2009/0322639 A1
(43) Pub. Date: Dec. 31, 2009

(54) ANTENNA APPARATUS

(75) Inventor: Ming-Iu Lai, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/485,896

(22) Filed: Jun. 16, 2009

(30) Foreign Application Priority Data
Jun. 27, 2008 (TW) 97124265

(51) Int. Cl. H01Q 1/38; H01Q 13/10

(52) U.S. Cl. 343/770; 343/700 MS

(57) ABSTRACT

An antenna apparatus including a metal layer, a first planar antenna, a second planar antenna and a conducting wire is provided. The first planar antenna has a first ground terminal electrically connected to the metal layer. The second planar antenna has a second ground terminal electrically connected to the metal layer. The conducting wire is connected between the first planar antenna and the second planar antenna. In the whole operation, electromagnetic signals transmitted by the first planar antenna and the second planar antenna are in the same frequency band, and the coupling effect of the first planar antenna and the second planar antenna is reduced along with the formation of a current loop of the conducting wire.

### CROSS-REFERENCE TO RELATED APPLICATION

This application claims the priority benefit of Taiwan application serial no. 97124265, filed on Jun. 27, 2008. The entirety of the above-mentioned patent application is hereby incorporated by reference herein and made a part of specification.

### BACKGROUND OF THE INVENTION

1. Field of the Invention

The invention relates to an antenna apparatus and, more particularly, to an antenna apparatus which may reduce the coupling effect using a conducting wire connected between two planar antennas.

2. Description of the Related Art

In recent years, to meet the users' growing demand for the connection between computers and various peripheral equipment or consumptive devices, electronic devices nowadays need various built-in wireless transmission functions such as the functions of the global positioning system (GPS), the communication system for mobile communications (GSM), the wireless local area network (WLAN), the wireless metropolitan area network (WMAN), the wireless metropolitan area network (WMA), the digital TV and so on.

With the progress and the development of hardware equipment and technology used in wireless transmission, the multi-input multi-output (MIMO) technology is gradually used in the GSM, the WLAN, the WMAN and other systems. Multiple antennas in the MIMO system operate together, and thus compared with the conventional system having a single antenna, the MIMO system has the characteristic that the reliability, the transmission speed and the receiving scope are improved. This makes the MIMO technology become a mainstream technology used in the wireless transmission in the future.

In the wireless network which mainly uses the MIMO technology, multiple antennas should be disposed in an electronic device to form a multi-path transmission mechanism. In addition, to prevent the coupling effect of the antennas, in the electronic devices nowadays, distance between antennas are always increased to reduce the coupling effect. This is not only unable to prevent the coupling effect effectively, but also occupies large space of the electronic device.

### BRIEF SUMMARY OF THE INVENTION

The invention provides an antenna apparatus including a metal layer, a first planar antenna, a second planar antenna and a conducting wire. The first planar antenna has a first ground terminal electrically connected to the metal layer. The second planar antenna has a second ground terminal electrically connected to the metal layer. The conducting wire is connected between the first planar antenna and the second planar antenna. In addition, electromagnetic signals transmitted by the first planar antenna and the second planar antenna are in the same frequency band.

In the invention, two ends of the conducting wire are electrically connected to the first planar antenna and the second planar antenna, respectively. Then, a current loop is formed to reduce the coupling effect of the first planar antenna and the second planar antenna. Thus, distance between antennas may be reduced, and the antenna apparatus may become mini in size.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing the structure of an antenna apparatus in a first embodiment of the invention.

FIG. 2 is a schematic diagram showing the equivalent circuit of the antenna apparatus 100 in FIG. 1.

FIG. 3 is a schematic diagram showing the structure of the antenna apparatus in a second embodiment of the invention.

FIG. 4 is a schematic diagram showing the structure of the antenna apparatus in a third embodiment of the invention.

### DETAILED DESCRIPTION OF THE EMBODIMENTS

In the following embodiments, elements with the same or similar functions or structures are illustrated with the same symbols and names.

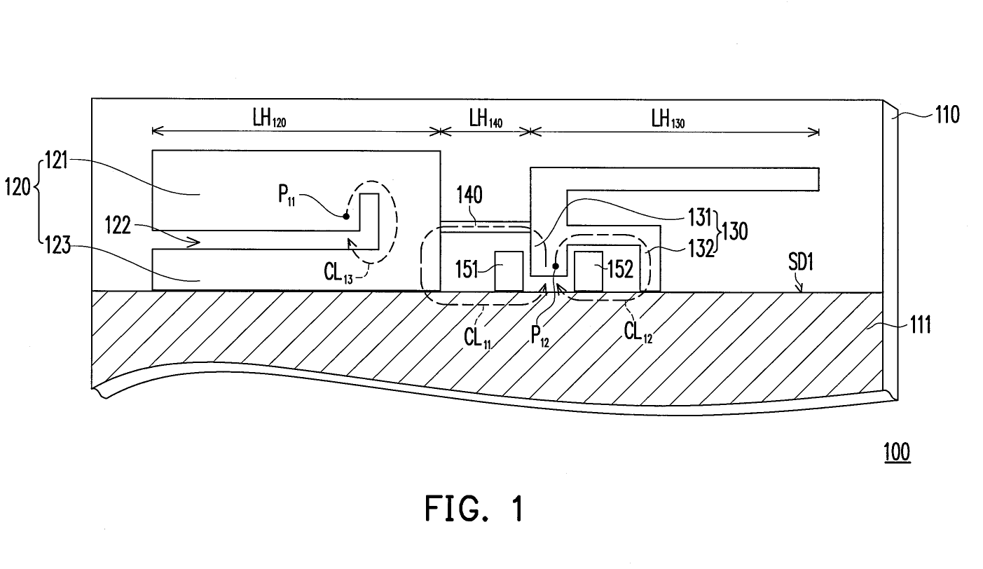

FIG. 1 is a schematic diagram showing the structure of an antenna apparatus in a first embodiment of the invention. As shown in FIG. 1, the antenna apparatus 100 includes a substrate 110, a first planar antenna 120, a second planar antenna 130 and a conducting wire 140. A metal layer 111 is disposed on the substrate 110, and the substrate 110 is, for example, a printed circuit board. In addition, the first planar antenna 120, the second planar antenna 130 and the conducting wire 140 are disposed on the substrate 110.

In the whole structure, the first planar antenna 120 and the second planar antenna 130 are arranged side by side along the side SD1 of the metal layer 111. In addition, the first planar antenna 120 and the second planar antenna 130 are electrically connected to the side SD1 of the metal layer 111. In another aspect, the conducting wire 140 is parallel with the side SD1 of the metal layer 111 and is disposed between the first planar antenna 120 and the second planar antenna 130. Moreover, two ends of the conducting wire 140 are electrically connected to the first planar antenna 120 and the second planar antenna 130, respectively.

In the whole operation, electromagnetic signals transmitted by the first planar antenna 120 and the second planar antenna 130 are in the same frequency band. When the electromagnetic signals are transmitted by the two planar antennas 120 and 130, the coupling effect of the two planar antennas 120 and 130 may be greatly reduced by the current loop formed by the conducting wire 140. The current loop formed by the conducting wire 140 for the planar antennas 120 and 130 are illustrated hereinbelow.

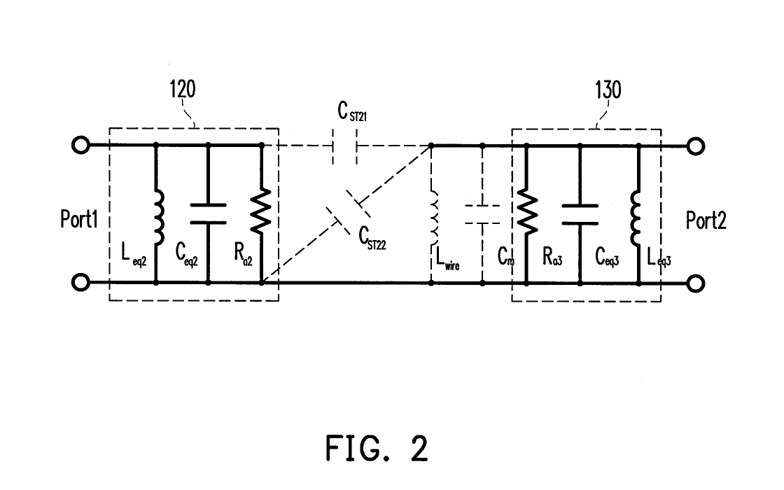

FIG. 2 is a schematic diagram showing the equivalent circuit of the antenna apparatus 100 in FIG. 1. As shown in FIG. 1 and FIG. 2, with respect to the circuit design, the first planar antenna 120 may be roughly modeled, and the model is composed of a radiation resistance Rₐ₂, an inductor L_{eq2} and a capacitor C_{eq2} which are connected to each other in a parallel connection. Similarly, the second planar antenna 130 also may be modeled, and it is composed of a radiation resistance Rₐ₃, an inductor L_{eq3} and a capacitor C_{eq3} which are connected to each other in a parallel connection.

When the planar antennas 120 and 130 are disposed too close to each other, stray capacitors C_{ST21} and C_{ST22} may be formed between the planer antennas 120 and 130. Thus, the coupling effect may be generated. However, when the conducting wire 140 is electrically connected between the two planar antennas 120 and 130, the conducting wire 140 may be equivalent to the inductor L_{wire} shown in FIG. 2. At that moment, as shown in FIG. 1, a current loop CL₁₁ may be formed by the conducting wire 140, and the coupling effect of the planar antennas 120 and 130 may be decreased.

In the first embodiment, the radiation mechanism of the first planar antenna 120 and that of the second planar antenna 130 are not the same. The first planar antenna 120 is composed of a slot antenna, and the second planar antenna 130 is composed of an inverted-F antenna. The first planar antenna 120 includes an upper area 121 and a ground terminal 123, and the second planar antenna 130 includes a feeding terminal 131 and a ground terminal 132.

In the whole structure, the ground terminal 123 of the first planar antenna 120 is electrically connected to the metal layer 111, and the upper area 121 is connected to the ground terminal 123 to form a slot 122. In another aspect, the feeding terminal 131 of the second planar antenna 130 is adjacent to the upper area 121 of the first planar antenna 120. In addition, the ground terminal 132 of the second planar antenna 130 is electrically connected to the metal layer 111. The feeding terminal 131 is electrically connected to the conducting wire 140.

The current loop formed by the first planar antenna 120 and the second planar antenna 130 may vary with the radiation mechanisms. The current loop denoted by CL₁₃ is a current loop formed by the first planar antenna 120 from the signal feeding point P₁₁. The current loop denoted by CL₁₂ is a current loop formed by the second planar antenna 120 from the signal feeding point P₁₂.

As shown from FIG. 1, the current loop CL₁₁, formed by the conducting wire 140 may affect the current loop CL₁₂ formed by the second planar antenna 130. Thus, in the first embodiment, the antenna apparatus 100 further includes two metal assisting wires 151 and 152. The metal assisting wires 151 and 152 are disposed on the substrate 110, and they are disposed at two sides of the feeding terminal 131 of the second planar antenna 130, respectively.

In addition, the two metal assisting wires 151 and 152 are electrically connected to the metal layer 111, respectively. Thus, as shown in FIG. 2, with respect to the circuit design, the two metal assisting wires 151 and 152 may be equivalent to a capacitor Cm to reduce the effect made by the current loop CL₁₁ upon the reflectance of the second planar antenna 130. In other words, the two metal assisting wires 151 and 152 may help to improve the reflection coefficient of the second planar antenna 130.

As shown in FIG. 2, when the conducting wire 140 and two metal assisting wires 151 and 152 are disposed in the antenna apparatus 100, the reflection coefficient S₁₁ seen from the circuit terminal Port 1 of the first planar antenna 120 and the reflection coefficient S₂₂ seen from the circuit terminal Port 2 of the second planar antenna 130 are reduced. In addition, the isolation (the S₂₁) of the planar antennas 120 and 130 increases, and the characteristic of the antenna apparatus 100 is improved.

In addition, as shown in FIG. 1, in actual application, the length LH120 of the first planar antenna 120 is substantially equal to the length LH130 of the second planar antenna 130. Furthermore, the length LH140 of the conducting wire 140 is equal to or less than half of the length of the first planar antenna 120 or the second planar antenna 130. Thus, the hardware space of the antenna apparatus 100 may be reduced.

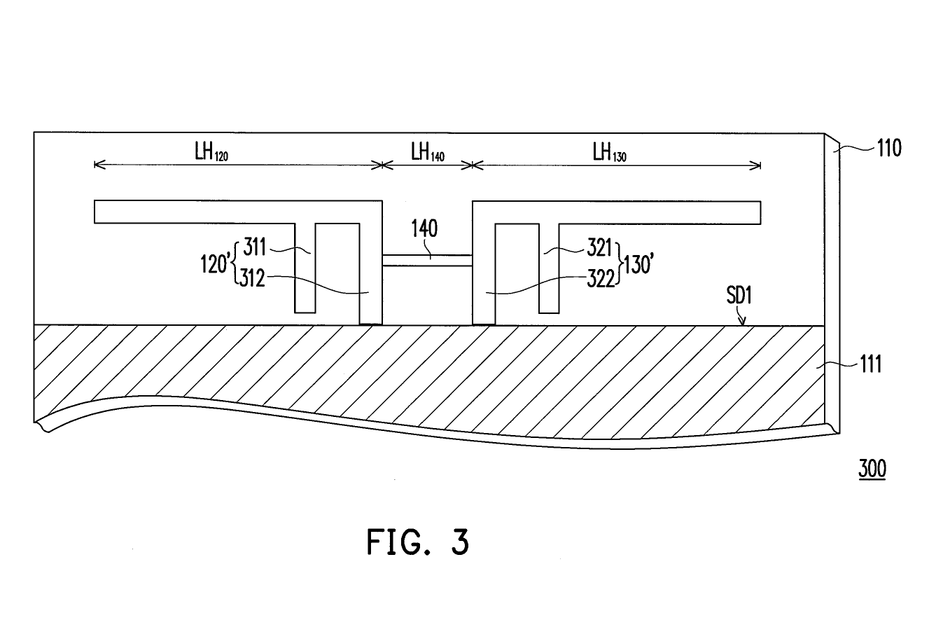

FIG. 3 is a schematic diagram showing the structure of the antenna apparatus in a second embodiment of the invention. As shown in FIG. 3, the main difference between the second embodiment and the first embodiment is that in the second embodiment, the radiation mechanism of the first planar antenna 120′ is the same as that of the second planar antenna 130′. Each of the first planar antenna 120′ and the second planar antenna 130′ is composed of an inverted-F antenna.

In the antenna apparatus 300, the first planar antenna 120′ includes a feeding terminal 311 and a ground terminal 312. Similarly, the second planar antenna 130′ includes a feeding terminal 321 and a ground terminal 322. In the whole structure, the ground terminal 312 of the first planar antenna 120′ is adjacent to the ground terminal 322 of the second planar antenna 130′. In addition, the first planar antenna 120′ is electrically connected to the metal layer 111 and the conducting wire 140 via the ground terminal 312. Similarly, the second planar antenna 130′ is electrically connected to the metal layer 111 and the conducting wire 140 via the ground terminal 322.

In addition, electromagnetic signals transmitted by the first planar antenna 120′ and the second planar antenna 130′ are in the same frequency band, which is similar to the first embodiment. When the electromagnetic signals are transmitted by the planar antennas 120′ and 130′, the conducting wire 140 disposed between the two planar antennas 120′ and 130′ may effectively reduce the coupling effect of the two planar antennas 120′ and 130′.

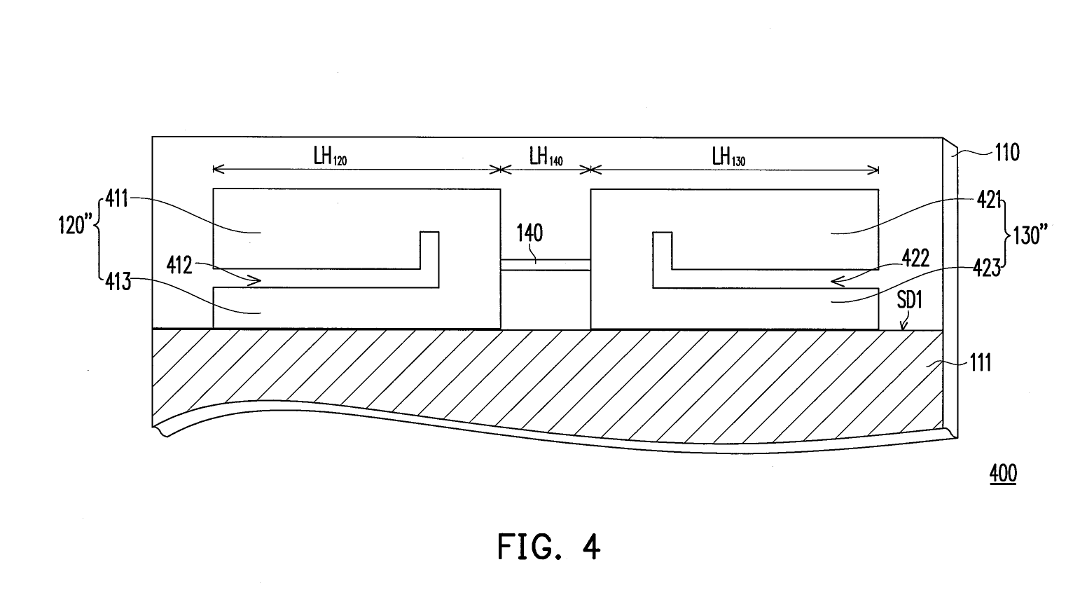

FIG. 4 is a schematic diagram showing the structure of the antenna apparatus in a third embodiment of the invention. As shown in FIG. 4, the difference between the third embodiment and the former embodiments is, in the third embodiment, the radiation mechanism of the first planar antenna 120″ is the same as that of the second planar antenna 130″, and each of the first planar antenna 120″ and the second planar antenna 130″ is composed of a slot antenna.

In the antenna apparatus 400, the first planar antenna 120″ includes an upper area 411 and a ground terminal 413. The upper area 411 is connected to the ground terminal 413 to form a slot 412. In another aspect, the second planar antenna 130″ includes an upper area 421 and a ground terminal 423. The upper area 421 is connected to the ground terminal 423 to form a slot 422.

Electromagnetic signals transmitted by the first planar antenna 120″ and the second planar antenna 130″ are in the same frequency band, which is the similar to the former embodiments. In addition, a conducting wire 140 is disposed between the two planar antennas 120″ and 130″. Thus, the current loop formed by the conducting wire 140 may reduce the coupling effect of the two planar antennas 120″ and 130″.

To sum up, in the invention, the conducting wire is disposed between two planar antennas to reduce the coupling effect of antennas. Thus, the characteristic of the planar antenna may be kept without increasing the distance of the antennas. In other words, the planar antenna in the invention does not need much space to be disposed in the antenna apparatus, and thus, the antenna apparatus may be mini in size.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An antenna apparatus comprising:
a metal layer;
a first planar antenna having a first ground terminal electrically connected to the metal layer;
a second planar antenna having a second ground terminal electrically connected to the metal layer; and
a conducting wire connected between the first planar antenna and the second planar antenna, wherein electromagnetic signals transmitted by the first planar antenna and the second planar antenna are in the same frequency band.

2. The antenna apparatus according to claim 1, wherein the first planar antenna is a slot antenna, and the second planar antenna is an inverted-F antenna.

3. The antenna apparatus according to claim 2, wherein the slot antenna comprises: the first ground terminal electrically connected to the metal layer; and an upper area connected to the first ground terminal to form a slot.

4. The antenna apparatus according to claim 3, wherein the conducting wire is connected to a portion where the upper area is connected to the first ground terminal.

5. The antenna apparatus according to claim 2, wherein the inverted-F antenna comprises:
the second ground terminal electrically connected to the metal layer; and
a feed-in terminal adjacent to the second ground terminal.

6. The antenna apparatus according to claim 5, wherein the conducting wire is connected to the feeding terminal.

7. The antenna apparatus according to claim 5, further comprising two metal assisting wires disposed at two sides of the feed-in terminal, respectively, and the two metal assisting wires being electrically connected to the metal layer.

8. The antenna apparatus according to claim 1, wherein the first planar antenna and the second planar antenna are inversted-F antennas.

9. The antenna apparatus according to claim 8, wherein the inverted-F antenna comprises:
the second ground terminal electrically connected to the metal layer and the conducting wire; and
a feed-in terminal adjacent to the second ground terminal.

10. The antenna apparatus according to claim 1, wherein the first planar antenna and the second planar antenna are slot antennas.

11. The antenna apparatus according to claim 10, wherein the slot antenna comprises:
the first ground terminal electrically connected to the metal layer; and
an upper area connected to the first ground terminal to form a slot.

12. The antenna apparatus according to claim 1, wherein the length of the first planar antenna is equal to the length of the second planar antenna.

13. The antenna apparatus according to claim 1, wherein the length of the conducting wire is less than or equal to half of the length of the first planar antenna or the second planar antenna.

14. The antenna apparatus according to claim 1, wherein the metal layer, the first planar antenna, the second planar antenna and the conducting wire are integrated on a substrate.

15. The antenna apparatus according to claim 1, wherein the substrate is a printed circuit board.
